(19) United States
(12) Patent Application Publication
(10) Pub. No.: US 2025/0095626 A1
(43) Pub. Date: Mar. 20, 2025

(54) METHOD FOR ACTIVELY MONITORING SOUND EMISSIONS OF TURBOMACHINERY, SYSTEM COMPRISING TURBOMACHINERY, AND DEVICE FOR CARRYING OUT THE METHOD

(71) Applicant: ZIEHL-ABEGG SE, Künzelsau (DE)

(72) Inventors: Frieder LOERCHER, Braunsbach (DE); Ferdinand HERRLICH, Schwabisch Hall (DE)

(21) Appl. No.: 18/845,999

(22) PCT Filed: Mar. 14, 2023
(86) PCT No.: PCT/DE2023/200057

§ 371 Date: Sep. 11, 2024

(30) Foreign Application Priority Data
Mar. 24, 2022 (DE) 102022202930.5

(51) Int. Cl. G10K 11/178

(52) U.S. Cl. CPC G10K 11/17821; G10K 2210/109; G10K 2210/3024

(57) ABSTRACT

A method for actively monitoring sound emissions of turbomachinery, in particular turbomachinery which has an electric motor, preferably a ventilator or a turbomachine. A sound signal, which is produced by superimposing the sound emission of the turbomachinery with at least one counter sound signal, is captured by at least one receiver at at least one receiver position and is transmitted to a control unit, wherein the control unit has an artificial intelligence, and a control signal is generated by the artificial intelligence for at least one actuator while taking into consideration the sound signal such that the actuator generates a counter sound signal that interacts with the sound emission of the turbomachinery such that a sound load at least in the region of the receiver position or the receiver positions is reduced.

### CROSS REFERENCE

This application is a national stage entry application under 35 U.S.C. 371 of PCT Patent Application No. PCT/DE2023/200057 filed on 14 Mar. 2023, which claims priority to German Patent Application No. 10 2022 202 930.5, filed on 24 Mar. 2023 the entire contents of each of which are incorporated herein by reference.

### FIELD

The disclosure relates to a method for actively controlling sound emissions of a flow machine, in particular a flow machine comprising an electric motor, preferably a fan or a turbomachine.

The disclosure further relates to a system having a flow machine, in particular a fan or turbomachine.

### BACKGROUND

Particularly in flow machines, there is regularly a need to constantly further minimize the noise emissions for given power data or at operating points or to optimize them in that the noise emissions are perceived in a subjectively more pleasant manner by a human. The use of flow machines or turbomachines or fans is and will increasingly be limited by the noise produced thereby. On the other hand, the development of increasingly low-noise devices, at least in the case of a predetermined construction size and drive torque, appears to approach natural lower limits in a rather asymptotic manner.

Many attempts at optimization may also have a very negative effect on energy, material or cost efficiency (example: passive sound damper technologies). For this reason, nowadays a great deal of hope is placed on so-called “active noise cancelling” (ANC), the approach of which is to cancel disruptive sound with where applicable phase-shifted counter-sound, to reduce it or also to configure it to be more pleasant for an affected person in a more complex approach (“sound design”). However, it is problematic to design corresponding systems as a result of the complexity of the sound events and the sensitivity thereof with respect to installation conditions, operating state of the flow machine and receiver position in a robust and reliable manner, for which reason a comprehensive use of ANC is still prevented particularly in the field of turbomachines and appears to be some way off.

Overall, consequently, the following steps for controlling sound emissions are known from the prior art:
ANC for systems with defined sound sources and receiver positions,
passive sound protection,
design of low-noise devices, for example, by configurations with reduced speeds.

### SUMMARY

An object of the present disclosure is to provide and further develop a method for actively controlling sound emissions of a flow machine so that, with little complexity, an optimization of the active controlling of sound emissions is achieved. Furthermore, there is intended to be set out a system with a flow machine which allows optimized active controlling of sound emissions. An apparatus for optimized active controlling of sound emissions of a flow machine is further intended to be set out.

According to the disclosure the above object is, in an embodiment, achieved by the feature of claim 1. As a result, a method for actively controlling sound emissions of a flow machine, which has an electric motor, in an embodiment of a fan or a turbomachine, is claimed, wherein a sound signal which is generated from superimposition of the sound emission from the flow machine with at least one counter-sound signal is recorded by at least one receiver at at least one receiver position and transmitted to a control unit, wherein the control unit has an artificial intelligence, wherein a control signal for at least one actuator is generated by the artificial intelligence taking into consideration the sound signal so that the actuator produces a counter-sound signal which cooperates with the sound emission of the flow machine so that a sound load at least in the region of the receiver position or the receiver positions is reduced or minimized, wherein at least two state values of the flow machine are transmitted to the control unit, wherein the control signal is generated by the artificial intelligence taking into consideration the state values.

With respect to the system according to the disclosure, the above-mentioned object is achieved, in an embodiment, by the features of claim 9. As a result, a system, for carrying out the method according to any one of claims 1 to 8, is claimed, having a flow machine, which has an electric motor, in an embodiment of a fan or a turbomachine, at least one receiver for detecting a sound signal at at least one receiver position, wherein the sound signal is generated from the superimposition of a sound emission generated by the flow machine and at least one counter-sound signal, having a control unit and at least one actuator, wherein the control unit has an artificial intelligence, wherein the artificial intelligence controls the actuator taking into consideration the sound signal detected and taking into consideration at least two state values of the flow machine so that it produces a counter-sound signal which cooperates with the sound emission of the flow machine so that a sound load at least in the region of the receiver position or the receiver positions is reduced or minimized.

With respect to the apparatus according to the disclosure, the above object is achieved, in an embodiment, by the features of claim 11. As a result, an apparatus, for carrying out the method according to any one of claims 1 to 8, is claimed, having at least one receiver for detecting a sound signal at at least one receiver position, wherein the sound signal is generated from superimposition of a sound emission produced by the flow machine and at least one counter-sound signal, a control unit and at least one actuator, wherein the control unit has an artificial intelligence, wherein the artificial intelligence controls the actuator taking into consideration the sound signal detected and taking into consideration at least two state values of the flow machine so that the actuator produces a counter-sound signal which cooperates with the sound emission of the flow machine so that a sound load at least in the region of the receiver position or the receiver positions is reduced or minimized.

It may be noted that the features of the method according to the disclosure may also be of a similar nature according to the apparatus. A combination of these features with the features relating to the system claim and/or with the features relating to the apparatus claim is not only possible but advantageous.

According to the disclosure, it has initially been recognized that a robust ANC system (active control of the sound by one or more additional sound sources, for example, for generating phase-shifted counter-sound) for flow machines or turbomachines or fans can be produced by an AINC (Artificially Intelligent Noise Cancelling) method being used. A dynamic counter-sound source or a plurality of counter-sound sources is/are thereby controlled. The term “robust” is intended to be understood in this instance to mean that the effectiveness of the system reacts rather less sensitively to changes of the operating state of the flow machine (speed, volume flow, pressure increase, etc.) and/or rather less sensitively to the installation surroundings of the flow machine and/or rather less sensitively to the receiver position. According to the disclosure the control unit with the artificial intelligence implemented therein is configured so that an optimized counter-sound signal is found for the respective configuration automatically after a short time. The disclosure is consequently based on the physical basis that, by superimposing a first sound signal with a second signal, which is phase-shifted by 180° and which is identical in terms of frequency and amplitude, a cancelling effect of the two signals is generated and consequently a reduced (cancelled in an ideal state) signal is produced at a receiver position. In another manner according to an embodiment of the disclosure, an existing flow machine can be retrofitted by the apparatus according to claim 11.

In an advantageous manner, a time signal and/or a frequency range and/or a phase position of the counter-sound which is generated by the actuator can be controlled by the control signal. Alternatively or additionally, the artificial intelligence can be trained beforehand, for example, at a factory. In an advantageous manner, the artificial intelligence could also use a reinforcing learning method (“reinforced learning”) in order to generate the control signal.

In an embodiment, a device-specific previously trained “reinforcement learning” control unit could adaptively control the time signals of the counter-sound sources so that noise signals at specific receiver positions are minimized or optimized with a psycho-acoustic consideration. To this end, control signals from a receiver or from a plurality of receivers are necessary at defined positions. Receiver positions can also be configured in an application-specific manner as a result of the flexibility of the AINC.

In a manner according to the disclosure, at least two state values of the flow machine are transmitted to the control unit, wherein the control signal is generated by the artificial intelligence taking into consideration the state values. Consequently, it is possible to react quickly and explicitly to changing operating states. In this case, it may be expressly noted that the expression “state values of the flow machine” is intended to be understood in that it includes all values which represent or describe the current operating state of the flow machine, and consequently also represent or describe the occurring sound emissions. This may also include components which cooperate with the flow machine, for example, the speed of an anemometer, the signal of a hot-wire anemometer or a differential pressure sensor.

Advantageously, the at least two state values may be
a motor speed of the flow machine and a speed of an impeller anemometer,
or a motor speed of the flow machine and a signal of a hot-wire anemometer,
or a motor speed of the flow machine and a motor current of the flow machine,
or a motor current of the flow machine and a speed of an impeller anemometer,
or a motor current of the flow machine and a signal from a hot-wire anemometer,
or a motor speed of the flow machine and a differential pressure upstream and downstream of the flow machine (when viewed in the flow direction),
or a motor current of the flow machine and a differential pressure upstream and downstream of the flow machine (when viewed in the flow direction). The above combinations of state values have the advantage that they particularly accurately represent the first sound result to be compensated for. In this case, other pairs of state values and/or combinations of more than two of the above-mentioned state values can also be used.

According to an embodiment, a microphone can be used as the receiver. Alternatively or additionally, the actuator may be a loudspeaker.

In an embodiment, the actuator may excite a component of the flow machine in order to emit sound. To this end, for example, a piezo-actuator could be used and/or a modulation of an excitation current or an excitation voltage could be carried out in an electric motor with a suitable, superimposed excitation signal. In specific terms, consequently, this could be structure-borne sound emissions via spectrally modulated excitation voltages, for example, of drive motors.

In a further embodiment, the control unit may be in the form of an integral component of the flow machine or the control unit may be in the form of a separate control module.

There are now different possible ways of configuring and further developing the teaching of the present disclosure in an advantageous manner. To this end, on the one hand, reference may be made to the claims dependent on claims 1 and 9 and, on the other hand, to the following explanation of exemplary embodiments of the disclosure with reference to the drawings. In connection with the explanation of the exemplary embodiments of the disclosure with reference to the drawings, embodiments and further developments of the teaching are also explained.

### BRIEF DESCRIPTION OF THE DRAWINGS

FIG. 1 shows a schematic illustration of an exemplary embodiment of a system according to the disclosure, on the basis of which the method according to the disclosure and the apparatus according to the disclosure are also described,

FIG. 2 shows a three-dimensional bar chart in which the pressure-side sound power L_{w}6 in dB of a fan is schematically illustrated as a function both of the motor speed and of the speed of an impeller anemometer,

FIG. 3 shows a view in the direction of the rotor axis and a section in a plane transverse relative to the rotor axis of a radial fan with a housing for which using the active sound controlling method is particularly suitable,

FIG. 4 shows a perspective view and a cross section, when viewed in a plane through the rotation axis of the rotor, of an embodiment of a fan, wherein an impeller anemometer which produces an anemometer speed as an input sensor variable for an active sound controlling method is provided,

FIG. 5 shows a perspective view when viewed from the inflow side of an exemplary embodiment of a fan with a carrier module having carrier struts in the form of redirecting vanes, for which using the active sound controlling method is particularly suitable,

FIG. 6 shows a side view and a sectioned view in a plane through the axis of a fan with a carrying redirecting unit (carrier module) with two different types of carrier struts in the form of redirecting vanes, and an intermediate ring, for which using the active sound controlling method is particularly suitable,

FIG. 7 shows a perspective view, when viewed from the outflow side, of an assembly of 4 parallel-connected fans, for which using the active sound controlling method is particularly suitable.

### DETAILED DESCRIPTION OF THE DISCLOSURE

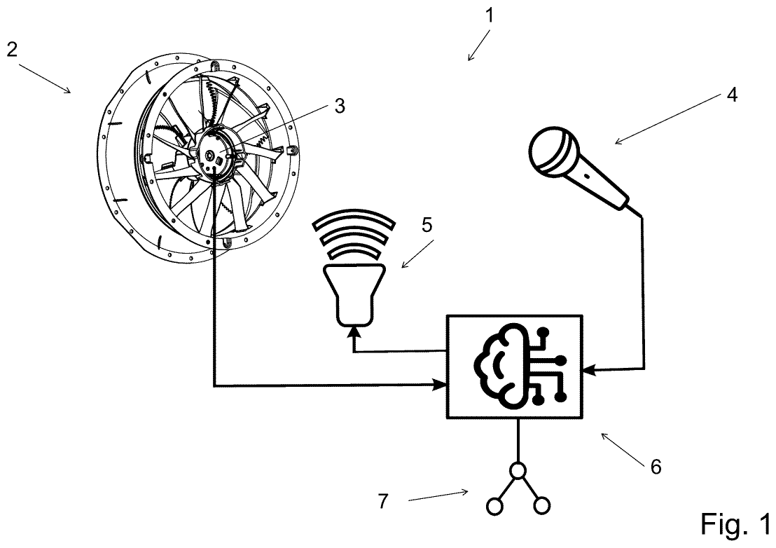

FIG. 1 shows a schematic illustration of a method of an artificially intelligently active sound control, particularly for flow machines, more particularly for turbomachines and more particularly for fans.

The illustration schematically shows a system 1, in this instance it is an AINC system (AINC stands for Active Intelligent Noise Control).

An electric flow machine 2 is operated in order to bring about an energy transfer (or power transfer) between a fluid and an electric connection. In the exemplary embodiment, the flow machine 2 is a turbomachine or fan which is driven by an electric motor 3. Consequently, it converts electrical energy into fluid energy (in particular, a total pressure increase in a conveying volume flow is brought about). The proposed technology also relates to flow machines which are operated by generator and which transfer power from a fluid to an electrical generator (for example, wind turbines). Experience shows that in this case regularly disruptive noise emissions (=first sound signal) are produced. This first sound signal is unavoidable at the source and more extensive reductions are often very complex in technical and/or developmental terms, given flow machines developed contemporarily according to the prior art.

The physical basis of the schematically shown method is the fact that, by superimposing a first sound signal with a second signal which is phase-shifted by 180° and which is identical in terms of frequency and amplitude, a cancellation effect of the two signals is produced and consequently at a receiver position a reduced signal (which is cancelled in an ideal state) is produced. For the purposes of physically generating one or more second sound signals (=second sound signals) which is/are used to cancel or reduce the total sound signal which is perceived at a receiver 4, the system 1 has an actuator 5. It has the ability to apply a counter-sound signal, which can be flexibly controlled with respect to the time signal and/or frequency range and/or phase positions, to the surrounding fluid medium, typically the conveying medium of the flow machine 2. A typical actuator 5 would be a loudspeaker, but also other actuators 5 are suitable and conceivable. Mention may be made in particular of the possibility of exciting components of the flow machine 2 itself to emit sound, for example, by piezo-actuators or by modulating an excitation current or an excitation voltage in the drive 3, for example, an electric motor, with a suitable superimposed excitation signal.

Generally, methods which use so-called counter-sound in this manner in order to cancel a predetermined sound source are adequately known by the term ANC (Active Noise Cancelling). In this case, one of the most important technical challenges is always determining and generating one or more suitable counter-sound signals. This is because, particularly in flow machines, the precise structure of the first sound signal is of interest at a receiver position, wherein it is unpredictable or only predictable with extreme difficulty or is unknown. For example, occurrences of turbulence which generate sound often do not have any deterministically predictable frequencies, phase positions or amplitudes. In addition, the sound event can vary powerfully in accordance with the receiver position. For various reasons, the sound generation can also depend powerfully on the installation situation of a turbomachine and cannot be predetermined in a representative manner with operation in the laboratory. For example, the inflow turbulences which influence the first sound signal significantly are significantly influenced by an installation condition at the inflow side. The transfer of the first sound signal to an observer will also be influenced significantly by the installation situation at the inflow or outflow side (depending on the observer position).

The proposed method further has one (or more) receiver(s) 4, for example, microphones, as also illustrated in FIG. 1. The total sound signal which is recorded in real time at that location represents the “receiver side”, at which the total sound is intended to be minimized as far as possible and/or optimized according to the object as far as possible with respect to a positive subjective perception. The recorded total sound signal is forwarded to the control unit 6 which has artificial intelligence (Artificial Intelligence module). There, initially an evaluation of this total sound signal has to be carried out with regard to its “quality”, which results in one or more quantitatively determinable characteristic variables, the optimization of which (minimization or maximization) represents the objective.

A simple example of a characteristic variable would be an A-evaluated sound pressure level. Other characteristic variables, such as, for example, characteristic variables from psycho-acoustics, can also be used, such as, for example, sharpness, harshness, tone incorporation, loudness, etc. The control unit 6 can, in an embodiment, have an interface 7, via which a user or a superordinate system can particularly control this evaluation and where applicable a weighting of different evaluation factors in a flexible manner, which can confer additional flexibility on the system.

A “Reinforcement Learning” algorithm can be used as the central basic algorithm, on which the establishment of the second sound signal(s) (counter-sound signals) by the control unit 6 is based, wherein other algorithms are also conceivable. This algorithm is known per se and is characterized by an adaptive behavior based on a reward principle. Set out in simplified terms, the second sound signal (counter-sound signal) is optimized by an algorithm based on trials until the total sound signal is optimized at the receiver or microphone 4 according to the evaluation criteria.

A “Reinforcement Learning agent” requires a “learning time” in which ultimately by a try and error strategy one or more optimal second sound signals are established. Therefore, it is proposed that an initial preliminary learning phase which is type-specific for the specific flow machine be carried out during operation in the laboratory and that the control unit 6 be configured accordingly beforehand in order to minimize the learning time in real operation. So that the control unit 6 can adapt the second sound signal rapidly and in real time to changing operating states of the flow machine 2, it is advantageously proposed that at least two state values which represent the current operating state of the flow machine 2 as well as possible be transmitted to the control unit 6. For example, the speed, motor current, speed of an impeller anemometer, signal of a hot-wire anemometer, differential pressures or signals of vibration sensors can be used. The control unit 6 uses these state values or measurement values directly to establish the second sound signal. The system can thereby adapt the second signal with higher dynamics to changing operating states of the flow machine which also result in a change of the acoustic first signal. The operating state of a flow machine can change with higher dynamics, for example, when the wind influences the load of the flow machine (wind turbine or turbomachine).

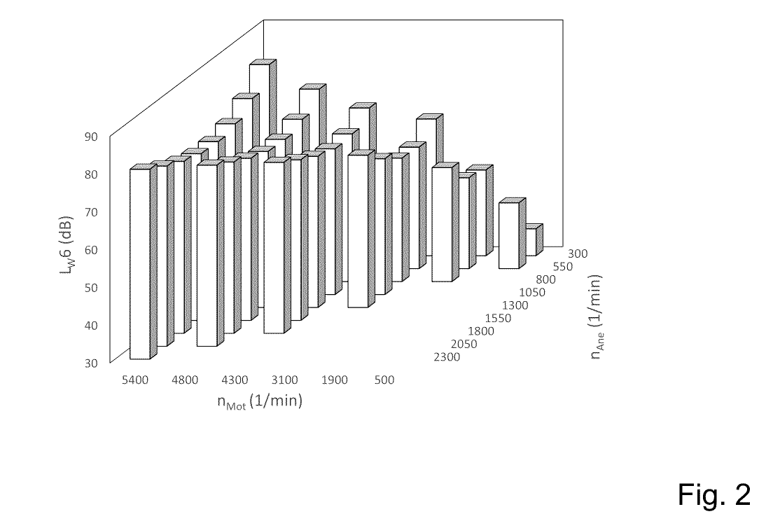

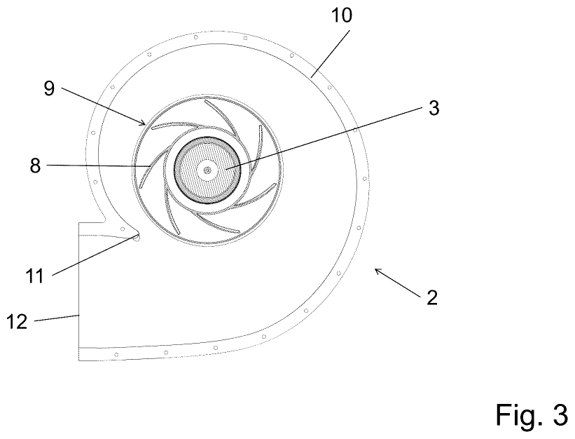

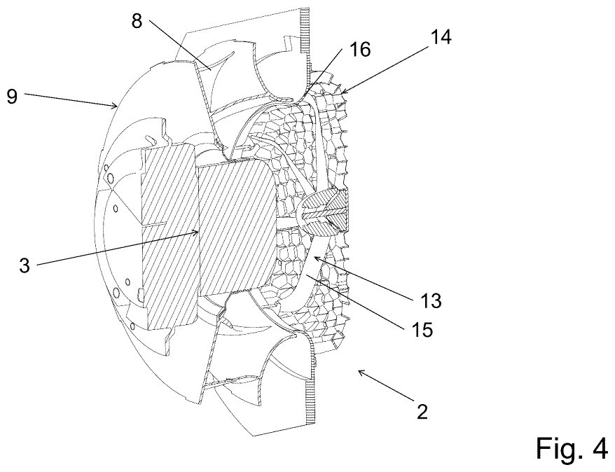

FIG. 2 schematically illustrates as a three-dimensional bar chart the pressure-side sound power L_{w}6 in dB of a fan similar to the fan according to FIG. 3 as a function both of the motor speed and of the speed of an impeller anemometer, as used to determine the conveying volume flow, for example, in a configuration similar to the one shown in FIG. 4. In this instance, bars not illustrated represent combinations which are not measured. The indication of the sound power is only one way of reducing a sound event to an individual characteristic value, wherein for each sound event a large number of possible characterizing characteristic values can be derived, for example, a sound power when viewed only in one freely selectable frequency range, a psycho-acoustic characteristic variable or, for example, the tonal proportion of the sound event. In any case, it is advantageous for the method according to the disclosure in order to actively control sound emissions of a flow machine if, as a result of the state values or sensor values which are transmitted during operation to the control unit, the sound event can be characterized as well as possible so that with rapid changes in state (state changes with high dynamics) of the sound event, the active sound control method can adapt the counter-sound signal (second sound signal) with high dynamics to the first sound event which is particularly dependent on the flow state of the flow machine in order to obtain a total sound event which is optimum as far as possible at the receiving microphone(s) as rapidly as possible.

The sound event of a flow machine, in particular of a fan, is powerfully linked to the flow state or operating state of the flow machine for a predetermined installation condition and for a constant conveying medium and is substantially predefined thereby. This means that it is then also possible to draw good conclusions relating to the produced first sound event from state values or sensor values, by means of which it is possible to draw good and clear conclusions as far as possible relating to the flow state of the flow machine. Consequently, in the active sound control method according to the disclosure, state values or sensor values which allow conclusions, which are as good and clear as possible and by means of which the sound control method can where applicable draw conclusions implicitly relating to the current first sound event, to be drawn regarding the flow state of the flow machine will advantageously be currently transmitted to the control unit during operation.

Typically, in flow machines, in particular fans, in a specific installation condition and with a specific conveying medium, the flow state and therefore also the produced first sound event depends on two parameters, in particular it is not usually sufficient to characterize the first sound event with only one characteristic variable or sensor variable. For example, this can readily be seen in the diagram which is depicted in FIG. 2 and which shows the pressure-side sound power L_{w}6 of a fan similar to the one depicted in FIG. 3 as a function of the motor speed n_{Mot} and the speed of an impeller anemometer n_{Ane}, which is fitted at the suction side to the fan, similar to the one of the impeller anemometer illustrated in FIG. 4. It can be seen that the sound power L_{w}6 is variable depending on the operating state of the fan. Even with knowledge of the motor speed n_{Mot}, it is impossible to draw good and clear conclusions relating to the sound power L_{w}6 and consequently the first sound event because it varies at a constant motor speed n_{Mot} in accordance with the anemometer speed n_{Ane}. This behavior at a constant n_{Mot} corresponds to a variation of the first sound event over a characteristic line of different throttle points of the flow machine at a constant speed n_{Mot}. If, however, the anemometer speed n_{Ane} is transmitted to the control unit of the active sound control method according to the disclosure in addition to the motor speed n_{Mot}, the optimum second sound signal(s) can be generated from the two measurement variables well and with high dynamics with regard to a changing first sound signal (which does not have to be explicitly calculated where applicable). It is further possible to become convinced, vice versa, that even with knowledge of only the anemometer speed n_{Ane}, good and clear conclusions cannot be drawn relating to the first sound event.

It is readily conceivable to transmit other pairs of state variables or sensor variables to the control unit of the active sound control method as long as they allow good and clear conclusions to be drawn as far as possible relating to the first sound event of the flow machine or the fan in the respective operating environment. There must be according to the disclosure at least two state values (per flow machine). Advantageous and highly possible pairings for which there are also suitable sensors are particularly:
a.) motor speed and speed of an impeller anemometer,
b.) motor speed and signal of a hot-wire anemometer,
c.) motor speed and motor current,
d.) motor current and speed of an impeller anemometer,
e.) motor current and signal of a hot-wire anemometer
f.) motor speed and a differential pressure,
g.) motor current and a differential pressure,
   or an alternatively set out pair, which is directly derived from such a pair, of identical information content items.

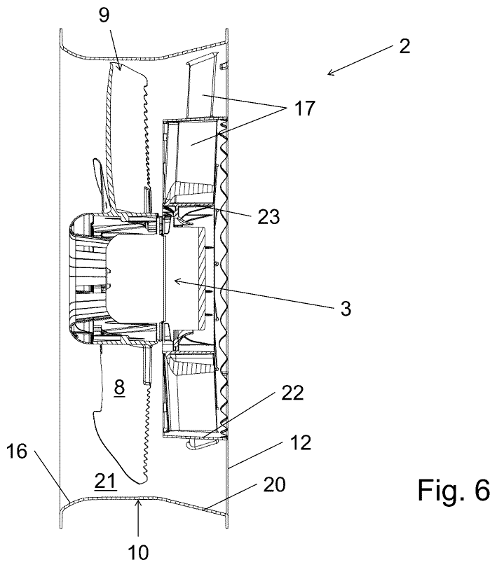

In an active sound control method according to the disclosure, in the case of several flow machines which are connected in parallel one behind the other and which are simultaneously operated (cf. example of FIG. 6), per active flow machine in current operation at least 2 sensor variables which characterize the flow state of the respective flow machine are transmitted to the control unit and processed in order to generate the second sound signal, at least as long as these sensor variables are independent of each other.

FIG. 3 illustrates, as a view in the viewing direction of the impeller axis and as a cross section in a plane transverse to the impeller axis, a flow machine 2 (fan) having a housing 10. The planar section which extends perpendicularly to the fan axis extends at the axial position at the center of the flow channel. In addition to the housing 10, the fan 2 particularly further comprises the drive 3 which is illustrated merely schematically in the section, and a rotor 9 or impeller 9 with vanes 8. The rotor 9 rotates during operation in a state driven by the drive 3, for example, an electric motor, advantageously an external rotor motor, in a clockwise direction when viewed in this view. Accordingly, it is a backwardly curved impeller 9, that is to say, an impeller 9 with backwardly curved vanes 8. The vanes 8 are curved counter to the direction of rotation, particularly if the extent of the vanes 8 is viewed from a radially internal position (from the front edge) in a radially outward direction (toward the rear edge).

During fan operation, the conveyed air is discharged radially outward out of the rotor 8 into the flow channel of the housing 10 which extends substantially in the circumferential direction with respect to the impeller axis. From a narrowest position in the region of the tongue 11, the flow channel widens in terms of its extent in the circumferential direction in order to receive the air flow which increases in the circumferential direction up to an outlet 12 out of the flow machine 2 or the helical housing 10. As a result of the interaction of the vanes 8 and the tongue or the scraper 11, wherein the rotating vanes 8 of the rotor 9 scrape past with the rear edge thereof during operation of the flow machine relatively near the tongue 11 or scraper 11, a rotation noise can be produced as a significant portion of a first sound signal. This rotation noise may be perceptible in a powerful, penetrating and unpleasant manner. Since it also has a rather discrete frequency and is rather low-frequency, such a fan 2 or such a flow machine 2 is very particularly suitable for the use of the sound control method according to the disclosure. For example, it is possible to use the rotor 9 as the actuator which is excited in a suitable manner, for example, via the drive 3. The housing 10 or the wall thereof can also be used in conjunction with a vibration-generating element as the actuator or a separate actuator can be secured within the housing 10. The rotation noise which is produced as the first sound portion is dependent on two sensor parameters of the flow machine 2, for example, the pair of the rotor speed n_{Mot} and anemometer speed n_{Ane}, for example, of an impeller anemometer (not illustrated) which is fitted upstream of the flow machine inlet. The rotor speed n_{Mot} determines in this case particularly the frequency of the rotation noise, wherein it also significantly influences the intensity thereof. The anemometer speed n_{Ane} significantly influences the intensity thereof.

In this embodiment and also in other embodiments with interaction of rotating and stationary components, it may be advantageous to use the current rotational angular position of the rotor as an additional input information item in the control unit. An information item is thereby known about the current phase position of rotation noises which are produced by this interaction, and depends on the relative rotational position of the rotating and stationary components. Usually, to this end, it is always simply necessary to have a signal (trigger, pulse) which indicates when a rotor passes a specific position. This can be achieved, for example, simply with a Hall sensor.

FIG. 4 shows a perspective view and a cross section in a plane through the rotation axis of the rotor 9 of an embodiment of a flow machine 2, in this case a fan 2, wherein a rotatable anemometer wheel 13 is fitted at the inflow side. The anemometer wheel 13 is substantially produced from a hub and vanes 15 which are secured thereto. The illustration clearly shows the anemometer wheel 13 and its bearing on a structure which is at the inflow side, in this case an inflow grid 14, which is fitted at the inflow side of a rotor 8 or an inflow nozzle 16, through which the inflowing conveying medium can flow into the rotor 8. The inflow grid 14 homogenizes the inflow and thereby increases the measurement accuracy of the impeller anemometer 13. During operation of the flow machine 2, the speed n_{Ane} of the impeller anemometer wheel 13 is constantly measured with suitable sensors, for example, Hall sensors. This speed n_{Ane} of the impeller anemometer 13 can advantageously be used as an input variable in an active sound control method. For example, together with the motor speed n_{Mot} of the drive 3 or the rotor 9, the operating state of the flow machine 2 and consequently the produced first sound signal can be characterized very well in a given operating environment. The control unit can produce a second sound signal which is as optimum as possible using this sensor signal with high dynamics.

The rotor 9/impeller 9 of the fan 2 is secured to the drive 3/motor 3. During operation, the rotor 9 rotates with its vanes 8 and conveys the conveying medium in this sequence through the inflow grid 14, over the anemometer wheel 13 through the inlet nozzle 16 and in the rotor 9 in a radially outward direction. There is thereby produced a first sound signal which may comprise a plurality of sound components, for example, tonal components, which can be produced by the interaction of the webs of the inflow grid 14 with the impeller anemometer 13 or the rotor 9 or the vanes 8 thereof, or tonal components which can be produced by the interaction of the impeller anemometer 13 which rotates as a result of the conveying volume flow freely at a speed n_{Ane}, which is dependent on the conveying volume flow, with the rotor 9 or the vanes 8 thereof. In order to reduce the acoustic annoyance of such a first sound signal at a receiver position, the active sound control method according to the disclosure produces at a control unit a second sound signal which is superimposed on the first sound signal and which allows the sound to be lower and/or more pleasant at a receiver position. In order to be able to react with high dynamics to a change of the first sound signal, the control unit also processes, in addition to at least one signal from a receiver microphone, advantageously at least two sensor variables which are measured constantly during operation and which accurately characterize the operating state of the flow machine. At the control unit, inter alia a Reinforcement Learning algorithm is used.

An impeller anemometer can be generally fitted, for example, to an inflow grid or in a housing, of a fan at the inflow side or outflow side of a rotor of a flow machine.

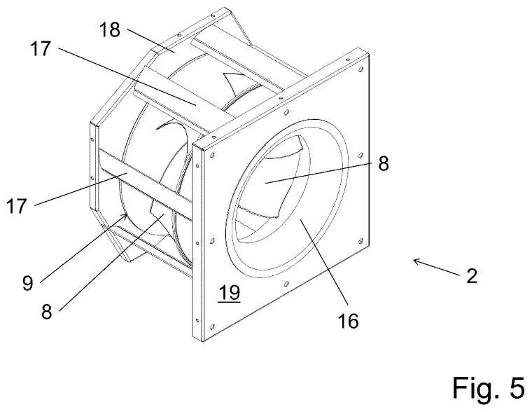

FIG. 5 shows a flow machine 2 (fan 2) having a carrier module having carrier struts 17 which are in the form of redirecting vanes 17 as a perspective view when viewed from the inflow side. There can be seen internally the rotor 9/the impeller 9 with the vanes 8 thereof, in this instance of a radial or diagonal construction type, which is driven in the exemplary embodiment during operation by a drive, which cannot be seen here, an electric external rotor motor. At the inflow side, furthermore, the inlet nozzle 16 which is fitted to a nozzle plate 19 and through which during operation of the flow machine 2 the conveying medium is drawn into the rotor 9 can be seen. The carrier module comprises, in addition to the nozzle plate 19, a base plate 18 and eight lateral carrier struts 17 radially outside the air outlet (at the outflow side) of the impeller/rotor 9. The carrier struts 17, which are in the form of redirecting vanes 17, have both an aerodynamic function since, as a result of their presence, the degree of efficiency of the flow machine 2 is increased, and a carrier function since they connect the nozzle plate 19 to the base plate 18 in a carrying manner and consequently ultimately retain the rotor 9 on the nozzle plate 19.

During operation of the fan/the flow machine 2, there is produced a first sound signal which may comprise a plurality of components, for example, components which are produced as a result of the interaction of the vanes 8 of the rotor 9 with the redirecting vanes 17 in the form of tonal and/or broad-band components. In order to reduce the acoustic annoyance of such a first sound signal at a receiver position, the active sound control method according to the disclosure produces at a control unit a second sound signal which is superimposed on the first sound signal and which allows the sound to become lower and/or more pleasant at a receiver position. Apart from the rotor 9, for example, the carrier module with the redirecting struts 17 thereof, nozzle plate 19 and base plate 18 can also be used as components for the actuator for generating the second sound signal. For example, piezo-actuators can be arranged there to excite an oscillation which produces the second sound signal.

FIG. 6 shows a side view and a cross section, in a plane through the axis, of a fan 2 (flow machine 2) with a carrying redirecting unit (carrier module) with two different types of carrier struts 17 which are in the form of redirecting vanes 17 and an intermediate ring 22, for which use of the active sound control method is particularly suitable. The carrier module particularly comprises two different types of redirecting vanes 17 (radially internal and radially external redirecting vanes 17), an intermediate ring 22 which connects the radially internal and radially external redirecting vanes 17 to each other, a hub ring 23, to which the drive 3 for the rotor 9 secured thereto is secured, and an external housing 10. The housing 10 contains here, in a one-piece and integral manner, the inlet nozzle 16, through which during operation of the flow machine 2 the conveying medium is drawn toward the rotor 9, a running region 21 which is advantageously substantially in the form of a cylinder covering and inside which the rotor 9 runs with the vanes 8 thereof and a diffuser 20, in which the external redirecting vanes 17 are secured, and the outflow-side end thereof forms the flow outlet 12 from the flow machine 2. The redirecting wheel comprising the external and internal redirecting vanes 17 and the intermediate ring 22 has both an aerodynamic function, which increases the degree of efficiency of the flow machine 2, and a carrier function since it connects the drive 3, in this case an electric external rotor motor, to the external housing 10, at which the flow machine 2 is connected to a superordinate unit, in a carrying manner. During operation of the fan 2/flow machine 2, there is produced a first sound signal which may comprise a plurality of components, for example, tonal and/or broad-band components which are produced as a result of the interaction of the vanes 8 of the rotor 9 with the redirecting vanes 17 or the intermediate ring 22. In order to reduce the acoustic annoyance of such a first sound signal at a receiver position, the active sound control method according to the disclosure produces at a control unit a second sound signal which is superimposed on the first sound signal and which allows the sound to become lower and/or more pleasant at a receiver position. Apart from the rotor 9, for example, the carrier module with the redirecting vanes 17 thereof or the housing 10 with the inlet nozzle 16, rotor region 21 or diffuser 20 can also be used as components for the actuator for generating the second sound signal. For example, piezo-actuators can be arranged there to excite an oscillation which produces the second sound signal. In such an embodiment, particularly also the speed n_{Mot} of the drive 3 or the rotor 9 in conjunction with the signal of a hot-wire anemometer can advantageously be used as a pair of sensor signals which accurately characterize the operating state of the flow machine 2 in an operating environment and which act as a current input into the control unit during the active sound control method.

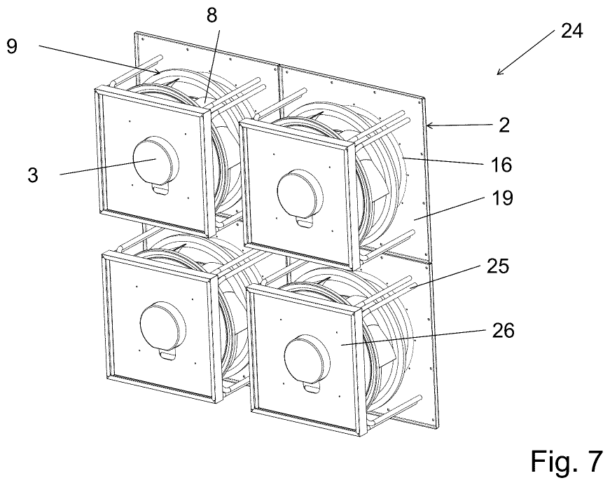

FIG. 7 shows a perspective view, when viewed from the outflow side, of an assembly of four parallel-connected flow machines 2/fans 2, for which using the active sound control method is highly suitable. These are flow machines 2/fans 2 without any housing which are arranged in a state connected in parallel beside each other. Each of the fans 2 has a nozzle plate 19, to which an inflow nozzle 16 through which the conveying medium during operation is drawn toward the rotors 9 is secured. At the nozzle plates 19, the drive 3 with the rotor 9 is secured via carrier struts 25. The rotors 9 particularly have vanes 8. In this embodiment, backflow blocking members 26 which prevent undesirable backflow downstream of the fans 2 in a region near the hub and which consequently increase the degree of efficiency of the fan assembly 24 are further attached to the fans 2.

The flow machine assembly 24 is highly suitable for using the sound control method according to the disclosure. However, the function thereof relates in such an assembly 24 to the whole of the flow machines 2 since at a receiver microphone a total sound, which cannot be uncoupled there, with contributions of all the flow machines is received. This means that there is a coupled sound control method for each flow machine assembly. As in an individual flow machine, in particular the signal from one or more microphones at receiver position(s) is used as the input signals into the control unit. With regard to the sensor signals which characterize the flow states of the flow machines, in the general case at least two sensor signals have to be transmitted to the control unit per flow machine in order to be able to detect the flow state per flow machine, as described with reference to FIG. 2. However, it may be good for the different flow machines to be connected with respect to one or more sensor variables. For example, they can all be operated at the same speed. They can also be connected with respect to their operating state (pressure increase or volume flow) depending on the arrangement, whereby under some circumstances it may be the case that all of the flow machines always run in the same operating state. If such a scenario can be ensured, depending on the arrangement only a reduced number of sensor signals can also be transmitted. However, a pair of sensor variables, which accurately and clearly characterize the flow state and consequently the first sound event in the present operating environment, must be able to be derived directly from the used sensor signals and connection conditions of the flow machines with respect to each other for each flow machine per se.

With regard to the actuators, there are also different possible approaches. Thus, the actuators can be distributed symmetrically over all the flow machines or a reduced number of actuators can be used. Generally, one or more actuators can be used per flow machine.

In the exemplary embodiment, in particular the backflow blocking member 26 and/or the nozzle plates 19 can be used in conjunction with vibration generators as effective actuators.

In an exemplary embodiment, as many elements as possible of the system 1 can be integrated in the flow machine 2. In particular, flow machines 2 with an electronic speed control, for example, via an electronically controlled frequency converter, have already in any case incorporated powerful electronic systems which may be able to be expanded relatively simply by the control unit 6, whereby advantageously an AINC control unit which is completely integrated in the electric motor or the electronic control unit thereof is provided.

In the example illustrated in FIG. 1, the flow machine 2 has an electric motor 3 with an integrated electronic control unit. The electric motor 3 is advantageously an external rotor motor in order to achieve a particularly compact construction type. The electric motor is advantageously an EC motor with an integrated electronic control unit, but it may also be an AC motor. Alternatively, the control unit 6 can be integrated as an insulated module in the region of the flow machine 2. As already described, the actuator 5 can advantageously also be integrated near the flow machine. It would be connected in the most compact manner and with the lowest additional complexity in terms of hardware to excite available components, in particular vanes of the flow machine 2, for example, via available windings of the electric machine with signals which can be controlled by the control unit 6. The excitation of structural components via actuators, for example, piezo-actuators, is also conceivable. The use of loudspeakers which are integrated near flow machines, for example, in or on a housing, is also conceivable. An important advantage of actuators 5 which are integrated near flow machines and consequently near the source with respect to the first sound signal is the directional dependence, which is then rather lower, of the desired effect of the second sound signal which is emitted via the actuators 5.

Embodiments are also conceivable in which one or more microphone signals which are recorded near the sound sources, that is to say, the flow machines, and which instead represent the first sound signal are used as the input into the control unit.

Depending on the embodiment, the functionality of the described active sound control can also be retrofitted in flow machines which are already developed or produced or in operation, for example, as an optional product function expansion or as an add-on, as claimed in the independent claim 11. Required additional hardware components (for example, microphones or actuators) would then have to be connected or attached to present interfaces. Software components can where applicable be installed on available hardware.

With respect to other advantageous embodiments of the method according to the disclosure and the apparatus according to the disclosure, reference may be made to the general part of the description and the appended claims in order to avoid repetition.

Finally, it may expressly be noted that the above-described exemplary embodiments of the method according to the disclosure and the apparatus according to the disclosure serve merely to explain the claimed teaching but do not limit it to the exemplary embodiments.

### LIST OF REFERENCE NUMERALS

1 System
2 Flow machine, fan
3 Drive (flow machine)
4 Receiver
5 Actuator
6 Control unit
7 Interface
8 Vane of a rotor
9 Rotor
10 Housing
11 Tongue, scraper
12 Flow outlet from flow machine
13 Impeller anemometer
14 Inflow grid
15 Vane of an impeller anemometer
16 Inflow nozzle
17 Redirecting vane
18 Carrier plate
19 Nozzle plate
20 Diffusor
21 Running region for rotor
22 Intermediate ring of a redirecting wheel
23 Hub ring of a redirecting wheel
24 Fan assembly, flow machine assembly
25 Carrier struts
26 Backflow blocking member

1. A method for actively controlling sound emissions of a flow machine having an electric motor of a fan or a turbomachine, comprising:
generating a sound signal from superimposition of a sound emission from the flow machine with at least one counter-sound signal recorded by at least one receiver at at least one receiver position and transmitted to a control unit, wherein the control unit has an artificial intelligence,
generating a control signal for at least one actuator by the artificial intelligence taking into consideration the sound signal so that the actuator produces a counter-sound signal which cooperates with the sound emission of the flow machine so that a sound load at least in the region of the receiver position or the receiver positions is reduced,
wherein at least two state values of the flow machine are transmitted to the control unit, wherein the control signal is generated by the artificial intelligence taking into consideration the state values.

2. The method as claimed in claim 1, wherein at least one of a time signal and a frequency range and a phase position of the counter-sound signal which is generated by the actuator is controlled by the control signal.

3. The method as claimed in claim 1, wherein the artificial intelligence uses a reinforcement learning method in order to generate the control signal.

4. The method as claimed in claim 1, wherein the artificial intelligence is trained beforehand.

5. The method as claimed in claim 1, wherein at least one state value is the measurement value of a corresponding sensor.

6. The method as claimed in claim 1, wherein the at least two state values are:
a motor speed of the flow machine and a speed of an impeller anemometer,
or a motor speed of the flow machine and a signal of a hot-wire anemometer,
or a motor speed of the flow machine and a motor current of the flow machine,
or a motor current of the flow machine and a speed of an impeller anemometer,
or a motor current of the flow machine and a signal from a hot-wire anemometer,
or a motor speed of the flow machine and a differential pressure upstream and downstream of the flow machine,
or a motor current of the flow machine and a differential pressure upstream and downstream of the flow machine.

7. The method as claimed in claim 1, wherein at least one of a microphone is used as the receiver and a loudspeaker is used as the actuator.

8. The method as claimed in claim 1, wherein the actuator excites a component of the flow machine in order to emit sound.

9. A system, for actively controlling sound emissions comprising:
a flow machine having an electric motor of a fan or a turbomachine,
at least one receiver for detecting a sound signal at at least one receiver position, wherein the sound signal is generated from the superimposition of a sound emission generated by the flow machine and at least one counter-sound signal,
a control unit, and
at least one actuator, wherein the control unit has an artificial intelligence, wherein the artificial intelligence controls the actuator taking into consideration the sound signal detected and taking into consideration at least two state values of the flow machine so that it produces a counter-sound signal which cooperates with the sound emission of the flow machine so that a sound load at least in the region of the receiver position or the receiver positions is reduced.

10. The system as claimed in claim 9, wherein the control unit is one of an integral component of the flow machine and a separate control module.

11. An apparatus, for actively controlling sound emissions of a flow machine comprising:
at least one receiver for detecting a sound signal at at least one receiver position, wherein the sound signal is generated from superimposition of a sound emission produced by a flow machine and at least one counter-sound signal,
a control unit and
at least one actuator, wherein the control unit has an artificial intelligence, wherein the artificial intelligence controls the actuator taking into consideration the sound signal detected and taking into consideration at least two state values of the flow machine so that the actuator produces a counter-sound signal which cooperates with the sound emission of the flow machine so that a sound load at least in the region of the receiver position or the receiver positions is reduced.

12. The method as claimed in claim 8, wherein the actuator excites the component of the flow machine via at least one of:
a piezo-actuator;
modulation of an excitation current; and
an excitation voltage in an electric motor with a suitable, superimposed excitation signal.
